(19) United States
(12) Patent Application Publication
(10) Pub. No.: US 2006/0158694 A1
(43) Pub. Date: Jul. 20, 2006

(54) Halftone processing apparatus and method thereof

(75) Inventor: Yong-Jo Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/320,321

(22) Filed: Dec. 29, 2005

(30) Foreign Application Priority Data
Jan. 17, 2005 (KR) 2005-0004291

(51) Int. Cl. H04N 1/405

(52) U.S. Cl. 358/3.06

(57) ABSTRACT

A halftone processing apparatus and a method thereof is provided to store halftone tables of different sizes and perform different halftone processes using the halftone tables of different sizes according to the type input image.

### CROSS-REFERENCE TO RELATED APPLICATIONS

This application claims the benefit under 35 U.S.C. § 119(a) of Korean Patent Application No. 10-2005-4291, filed on Jan. 17, 2005, the entire disclosure of which is hereby incorporated by reference.

### BACKGROUND OF THE INVENTION

1. Field of the Invention

The present invention relates to an image printing apparatus. More particularly, the present invention relates to a halftone processing apparatus and a method thereof that improves printing quality.

2. Description of the Related Art

In a laser printer, the final image is a 1-bit image using 1-bit per pixel. Therefore, images such as color or gray images are among the printing data which is outputted from a driver of a host. The image uses several bits per pixel and is converted into a 1-bit image. This is called a halftone image. In halftone images, various print qualities can be obtained according to the type of halftone table utilized.

Therefore, it is an important factor to obtain an optimal halftone table in order to improve image quality.

FIG. 1 is a block diagram showing a structure for processing of a halftone. This process comprises an image input buffer 20 for storing and maintaining image data included in a printing command, a halftone processing module 10 for performing a halftone process with the input image, and an image output buffer 40 for storing the image for which a halftone process is completed. The halftone processing module 10 reads a halftone table 30 stored into a memory and uses it for halftone processing.

A multi-bit pixel image (a color or a gray image) is stored into the image input buffer 20 by the halftone processing module 10 and the halftone is processed and stored into the image output buffer 40. At this time, the image stored into the image output buffer 40 becomes a 1-bit pixel image in which the value of 1 pixel is represented by 1-bit. Generally, in a case of printing using a printer, a multi-bit image, that is, a gray scale image is converted into a 1 bit bitmap by using a binarization image conversion. Subsequently, the image is printed.

At this time, an original image pixel having a gray level of multi-bits is converted into a 1-bit image by using a halftone value, and a 1-bit halftone processing method using a general halftone screen as is shown in FIGS. 2A-2C.

FIG. 2A is a diagram which shows an input image pixel having 8 bit pixels (256 level). FIG. 2B is a diagram also showing a halftone table. FIG. 2C is a diagram which shows an output image for which a 1-bit halftone process is performed.

A method for generating 1-bit images by applying a halftone table on an input image pixel will now be described. First, the entire image of 8×8 is divided into a halftone table of 8×8, and the input image pixel is compared with the halftone table. If the input image pixel is larger than the halftone table, 0 is set, and if the halftone table is larger than the input image pixel, 1 is set (or vice versa). Therefore, an 8 bit pixel is converted into a 1 bit pixel.

The patterns which correspond to each gray are also generated by such a method. For example, a pattern image of gray 100 means an image stored into the image output buffer and all pixel values of the image input buffer are set to 100. FIGS. 3A and 3B show a generation flow of the gray pattern. For example, if gray values of all pixels of an input image are set to 150, a gray pattern (FIG. 3B) generated through 16×16 halftone table (FIG. 3A) application is shown. In case that a source image has a solid gray value, this gray pattern may be used in ROP (Raster Operation) processing, so that the source image has a pattern to represent gray. For example, in the case of a font image, the image itself is composed of a source image of all black, but a gray level of 150 is designated. ROP processing is performed to delineate a destination image, and the gray pattern is covered with the source image of a font. Consequently, the destination image is delineated.

So far, generally only one halftone table has been used while performing a printing job for a halftone process. That is, when processing a full gray or full color image, or when processing a solid color or a solid gray image, the same halftone table is used. However, in light of halftone properties, it is preferable that a halftone table used for the solid color or the solid gray has a high LPI (Line per inch). Further, it is preferable that a full gray image uses a proper line between LPI and gray level. Accordingly, a problem arises in that poor image quality may be generated at the time of an image conversion if the same halftone table is used for two cases of input images.

Accordingly, there is a need for an apparatus which improves printing quality and a method thereof wherein different halftone tables are used according to the type of input image.

### SUMMARY OF THE INVENTION

An aspect of the present invention is to solve at least the above problems and/or disadvantages and to provide an apparatus which improves printing quality and a method thereof wherein different halftone tables are used according to the type of input image, thereby obtaining an image having improved quality. Another aspect is to provide a halftone processing method of an input image which performs a halftone process by using different halftone tables according to the type of input image.

Accordingly, it is preferable that the halftone table is composed of a relatively large sized halftone table having a low LPI, and a relatively small sized halftone table having a high LPI. It is preferable that a halftone process is performed by using a halftone table having a higher LPI in case that the input image is a solid image, and the processing is performed by using a relatively large sized halftone table having a lower LPI in a case where the input image is a full color or a full gray image.

Further, another aspect of the present invention is to provide a halftone processing method of an input image comprising a step for storing different halftone tables such as a relatively large sized halftone table having a low LPI, or a relatively small sized halftone table having a high LPI. Additional steps are provided for determining a type of input image, a step for performing a halftone processing by using the halftone table having a higher LPI when the input image is a solid image as a result of said determining result, and a step for performing a halftone processing by using the relatively large sized halftone table having a lower LPI when the input image is a full color or a full gray image.

The above objects are also accomplished by providing a halftone processing apparatus of an input image which comprises a memory which stores halftone tables having different sizes, and a halftone processing module which performs halftone processing by using the halftone tables of different sizes on the memory according to a type of input image. On the memory, a halftone table having a low LPI and a relatively large size, and a halftone table having a high LPI and a relatively small size are stored.

Accordingly, it is preferable that when the input image is a solid image, the halftone processing module reads a relatively large sized halftone table having a low LPI from the memory and performs a halftone process. Alternatively, when the input image is a full color or a full gray image, the halftone processing module reads a relatively small sized halftone table having a high LPI from the memory and performs a halftone process.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram which shows a conventional halftone process;

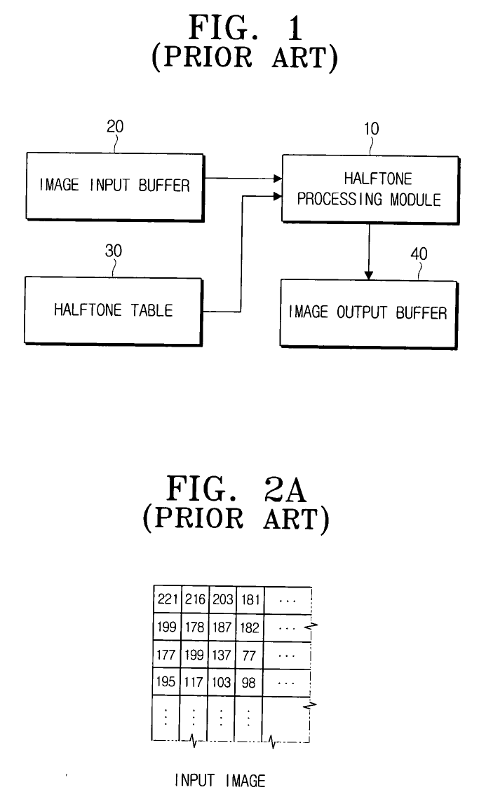

FIGS. 2A to 2C are diagrams showing an output image for which a halftone process is applied;

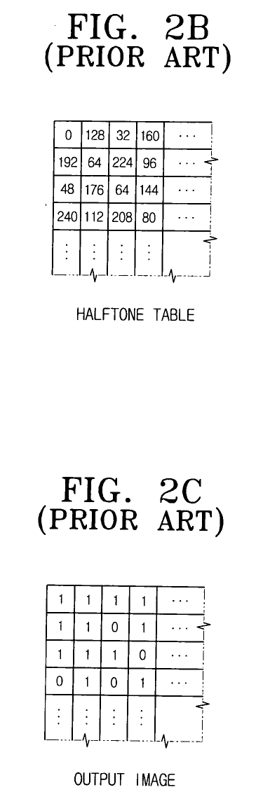

FIGS. 3A and 3B are diagrams showing the generation of a gray pattern;

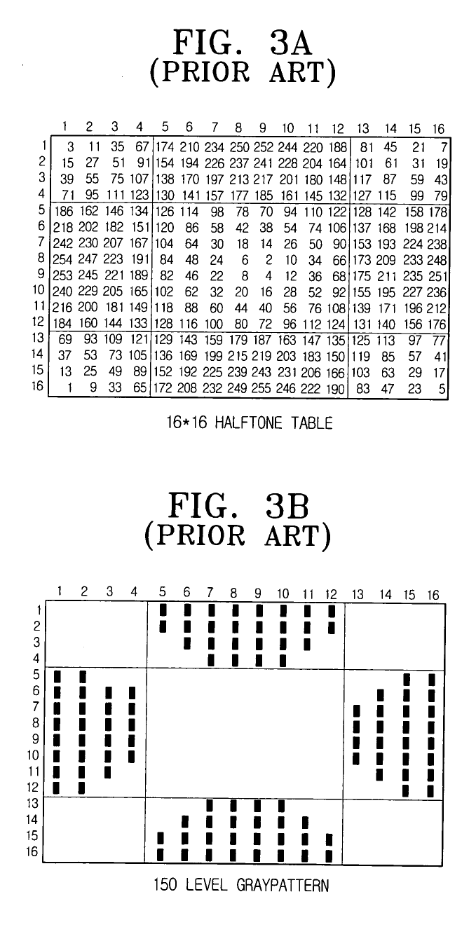

FIG. 4 is a block diagram showing a structure for a halftone process of an embodiment of the present invention; and

FIG. 5 is a flowchart illustrating a halftone process of an embodiment of the present invention.

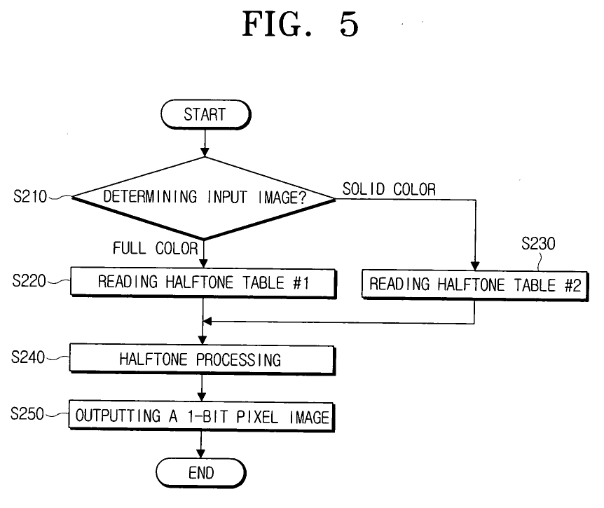

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

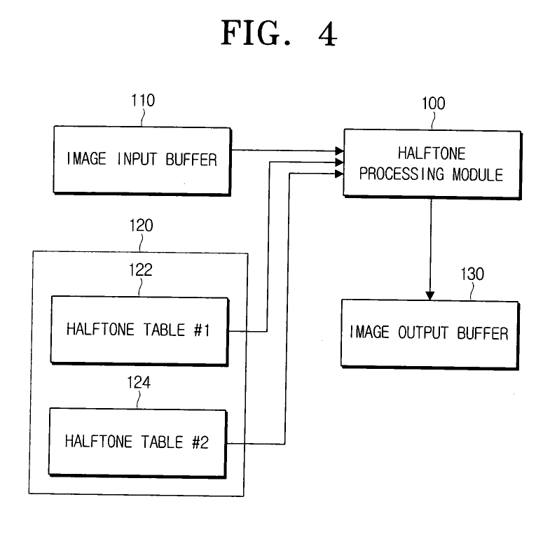

FIG. 4 is a block diagram showing a structure for a halftone process according to an embodiment of the present invention. The structure is composed of an image input buffer 110, a halftone processing module 100, a memory 120 and an image output buffer 130.

The image input buffer 110 stores and maintains image data included in a printing command

The memory 120 is designed to store a plurality of halftone tables. For example, a half tone table #1 122 having a large size and the sufficient gray level, and a half tone table #2 124 having a small size and a higher LPI compared with the sufficient gray level are stored. In the description of the exemplary embodiments of the present invention, it is assumed that a half tone table #1 122 uses a 16×16 halftone table, and a half tone table #2 124 a 12×12 halftone table.

The halftone processing module 100 outputs 1 bit images by performing halftone processing with the input image of the image input buffer 110.

At this time, the halftone processing module 100 judges whether each pixel of an image of the image input buffer 110 is a full color image having different values, or a solid color image having the same values. According to the determining result, the halftone processing module 100 reads the half tone table #1 122 of 16×16 size having a large size and a relatively lower LPI, and performs a halftone process, in case that the image is a full color or a full gray image. The halftone processing module 100 reads the half tone table #2 124 of 12×12 size having a small size and a relatively higher LPI, and performs a halftone process in a case where the image is a solid color or a solid gray image.

The image output buffer 130 stores a 1-bit pixel image for which a halftone process is completed in the halftone processing module 100.

Below, a halftone processing method according to one embodiment of the present invention will be explained.

The halftone processing module 100 judges whether an image in the image input buffer 110 is a full color or a full gray image, or a solid color or a solid gray image (S210). At this time, a determining method is as follows. If the image has a different value per pixel, it is judged as a full color or a full gray image. If the image has the same value per pixel, it is judged as a solid color or a solid gray image. Preferably, the determination is performed by sampling a predetermined number of the pixels of input images.

In the step S210, in a case where the image is judged as a full color or a full gray image, The halftone processing module 100 reads the half tone table #1 122 of 16×16 size having a large size and a relatively lower LPI, from the memory 120 (S220) and performs a halftone process (S240).

In the step S210, the halftone processing module 100 reads the half tone table #2 124 of 12×12 size having a small size and a relatively higher LPI from the memory 120 (S230), and performs a halftone process (S240), in a case where the image is judged as a solid color or a solid gray image. Thereby, a 1-bit pixel image is outputted and then stored into the image output buffer 130.

In above description, a 1-bit halftone process is described; however, the process can be used in a multi halftone process to which 2 bit halftone or 4 bit halftone is applied in order to improve image quality.

As described above, according to an apparatus which improves printing quality and a method thereof, halftone processing results can have improved results by selecting a different halftone table according to the properties of the input image. That is, in case of a solid color, in contrast to conventional cases, a halftone table having a high LPI is used and thereby the printing quality is relatively improved.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A halftone processing method of an input image, comprising the steps of performing a halftone process by using different halftone tables according to the input image.

2. The halftone processing method as claimed in claim 1, wherein the halftone table is composed of a relatively large sized halftone table having a low LPI, and a relatively small sized halftone table having a high LPI.

3. The halftone processing method as claimed in claim 2, wherein the halftone processing is performed by using the halftone table having a higher LPI, in a case where the input image is a solid image.

4. The halftone processing method as claimed in claim 2, wherein the halftone processing is performed by using the relatively large sized halftone table having a lower LPI in a case where the input image is a full color or a full gray image.

5. A halftone processing method of an input image, comprising the steps of:
storing different halftone tables including a relatively large sized halftone table having a low LPI, or a relatively small sized halftone table having a high LPI;
determining a type of the input image; and
performing the halftone process by using the halftone table having a higher LPI, in a case where the input image is a solid image as a result of the determination step.

6. The halftone processing method as claimed in claim 5, further comprising a step for performing the halftone process by using the relatively large sized halftone table having a lower LPI in a case where the input image is a full color or a full gray image as a result of the determination result.

7. A halftone processing apparatus of an input image, comprising:
memory configured to store halftone tables having different sizes; and
a halftone processing module which performs a halftone process by using the different halftone tables on the memory according to a type of the input image.

8. The halftone processing apparatus as claimed in claim 7, wherein the halftone tables of different sizes stored in the memory are a relatively large sized halftone table having a low LPI, and a relatively small sized halftone table having a high LPI.

9. The halftone processing apparatus as claimed in claim 8, wherein the halftone processing module reads the relatively large sized halftone table having a low LPI from the memory, and performs a halftone process in a case where the input image is a full color or a full gray image.

10. The halftone processing apparatus as claimed in claim 8, wherein the halftone processing module reads the relatively small sized halftone table having a high LPI from the memory and performs a halftone process in a case where the input image is a solid color or a solid gray image as a result of the determination result of the type of image.
